(19) United States
(12) Patent Application Publication
(10) Pub. No.: US 2009/0083087 A1
(43) Pub. Date: Mar. 26, 2009

(54) MODELING OF TASK-BASED CONSTRAINTS AND AUTOMATED POLICY DERIVATION

(76) Inventors: Christian Wolter, Leimen (DE); Andreas Schaad, Karlsruhe (DE)

Correspondence Address: SCHWEGMAN, LUNDBERG & WOESSNER/SAP, P.O. BOX 2938, MINNEAPOLIS, MN, 55402, US

(21) Appl. No.: 11/858,314

(22) Filed: Sep. 20, 2007

(51) Int. Cl. G06Q 10/00

(52) U.S. Cl. 705/7

(57) ABSTRACT

A method and system for the augmentation of at least one task of a business process model are described, such augmentation including receiving a task-based authorization constraint to be applied to the at least one task. An augmented business process model is generated utilizing the business process model and the task-based authorization constraint. An authorization policy is automatically derived from the augmented business process model.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2007, SAP AG, All Rights Reserved.

### BACKGROUND

In the domain of information systems security and compliance, access control is a technique to protect the company assets and to manage the availability of resources.

### BRIEF DESCRIPTION OF DRAWINGS

Some embodiments are illustrated by way of example and not limitation in the figures of the accompanying drawings in which:

FIG. 1 is a diagrammatic illustration of a use case for an augmented business process, according to an example embodiment.

FIG. 2 is a block diagram illustrating a policy generation framework, according to an example embodiment.

FIG. 3 is an interaction diagram illustrating an overall method, according to an example embodiment, for processing modeling and policy generation.

FIG. 4 is a diagrammatic representation of an extended process meta-model, according to an example embodiment.

FIG. 5 illustrates visual notations that may be used, according to an example embodiment, to represent the assignment of automatic and manual tasks to organizational roles.

FIG. 6 is a diagrammatic representation of notations, according to an example embodiment, that may be used to define groups of tasks.

FIG. 7 is a diagrammatic illustration of visual notations, according to an example embodiment, that may be used to represent an allocation of a constraint artifact (e.g., a binding of duty or a separation of duty) to a grouping of tasks.

FIG. 8 is a diagrammatic representation of an example process model, in which tasks of the process model are augmented with task-based authorization constraints.

FIG. 9 is a diagrammatic representation of a process-to-XACML mapping, according to an example embodiment.

FIG. 10 is a Petri-Net representation of a policy transformation, according to an example embodiment.

FIG. 11 is a diagrammatic representation of a simple separation of duty, as an XACML policy, according to an example embodiment.

FIG. 12 is a block diagram of a computer system within which are a set of instructions, for causing the computer system to perform any one of the methodologies discussed herein.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Example embodiments may be utilized by, for example, business experts to define compliance requirements and authorization constraints at a business process level, while at the same time enabling corresponding access control policies to be specified and enforced at the backend of an information system (e.g., an enterprise information system).

To this end, an example embodiment may be used, at the business process modeling level, to facilitate the capture of authorization constraints. An example embodiment may affirm or allow the specification of authorization constraints in an uncomplicated and user friendly manner.

Current business process modeling languages (e.g., Business Process Modeling Notation (BPMN), XML Process Definition Language (XPDL), Business Process Execution Language (BPEL), Architecture of Integrated Information System (ARIS)) may lack capabilities to capture authorization constraints in a convenient manner. Furthermore, authorization constraint specifications (e.g., the well-defined OASIS standardized eXtensible Access Control Markup Language (XACML)), while providing an expressive notation, may render policy definition somewhat cumbersome. The direct (and often manual) definition of XACML policies may prove to be slow, error prone and may lead to policy inconsistencies and disruption of related business process execution.

An example embodiment proposes an extension to the Business Process Modeling Language (e.g., BPMN) in order to support task-based access control, tailored to specify authorization constraints for task allocation (e.g., in business process environments). Further, an example embodiment provides a mapping between an enhanced business process modeling notation and an access control language (e.g., XACML) to provide model-driven extraction of security policies from a business process model. An example embodiment enables specific types of organizational control and compliance policies to be expressed in a graphical, textual or otherwise visual fashion at a business processing modeling level, and further enables the transformation of such policies into corresponding task authorization and access control policies for business process information systems.

This example approach may operate to enable better collaboration between security and business process domain experts to define consistent and valid security policies that may be clearly communicated.

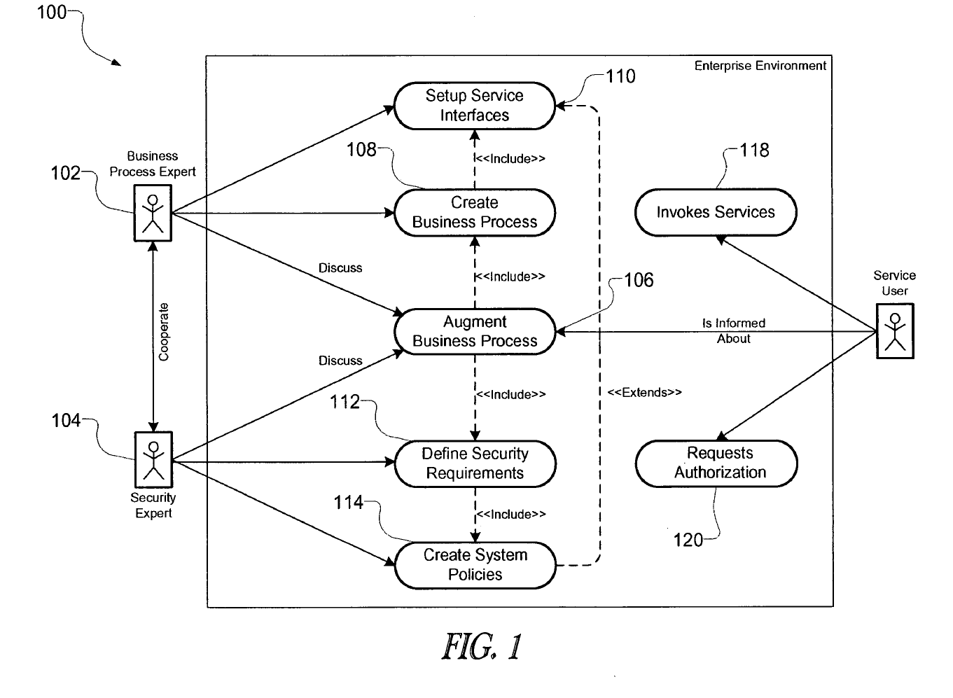

FIG. 1 is a diagrammatic representation, according to an example embodiment, of a use case for an augmented business process. Within the context of an enterprise environment 100, a business process expert 102 is shown to collaborate and cooperate with a security expert 104 on the creation and definition of authorization constraints that are used to generate an augmented business process 106. Each of the experts 102 and 104 may still be responsible for his or her domain or specific activities, but communications take place regarding the shared augmented business process 106. The illustrated process may furthermore link the activities of creating system policies of a security expert 104 with the activities of setting up the corresponding service interfaces by the business process expert 102. Specifically, the business process expert 102 is shown to maintain sole responsibility for the creation of business processes at 108 and the set up of service interfaces at 110. Similarly, the security expert 104 retains sole dominion of the definition of security requirements at 112 and the creation of security policies at 114. However, there is discussion and collaboration regarding the definition and creation of the augmented business process 106.

A service user 116 is furthermore shown to, within the context of the enterprise environment 100, to invoke services 118 (e.g., defined by the business process expert 102) and to request authorizations 120 (e.g., defined by the security expert 104).

Example benefits that may flow from the collaborative definition and creation of an augmented business process 106 include avoidance of the risk of inconsistent and invalid policies, where business processes and related services are modified by the business process expert 102. A further benefit that may flow is the transparency of security policies to service users 116. By using an accessible policy specification within the process model itself, communication and understanding of security restrictions may be easier for service users 116.

An exemplary embodiment enables the visual specification (e.g., using graphical or text notations) of task-based constraints by enriching the semantics of a business process modeling notation. Further, an example embodiment may enable the derivation of concrete security policies from an augmented business process model, and the transformation of such derived security policies into a dedicated policy security language.

Accordingly, in one example embodiment, there is proposed receiving, via an interface, an augmentation of at least one task of a business process model, the augmentation comprising a task-based authorization constraint. An augmented business process model is then generated utilizing the business process model and the task-based authorization constraint. An authorization policy is automatically derived from the business process model. The automatic derivation of the authorization policy may include extracting the task-based authorization constraint from the augmented business process model. The task-based authorization constraint may be received via the interface as a visual business process modeling notation for association with the at least one task of the business process model. The visual business process modeling notation may be at least one of a textual notation or a graphical notation.

In an example embodiment, the authorization policy automatically derived from the augmented business process model is a control policy. The at least one task of the business process model that is augmented with the task-based authorization constraints may be at least one of a manual task, a partially automated task, or a fully automated task.

The automatic derivation of the authorization policy may include detecting the task-based authorization constraint as represented within the augmented business process model, and generating a condition for the authorization policy based thereon. Further, the automatic derivation of the authorization policy may include determining whether the at least one task is a manual task and based on this determination, selectively applying an attribute function to the generated condition.

An example embodiment may further include enacting the enhanced business process model utilizing a workflow management system, and further enacting the authorization policy using a security system.

Below follows an overall architecture and supporting methods for an example modeling and policy generation framework for a visual task-based authorization specification. It should be appreciated that the approach may be independent of a specific business process modeling notation, as well as independent of any specific security language policy. However, for the purposes of explanation, an example embodiment discussed below uses BPMN as an example business process modeling notation and XACML as an example security policy language.

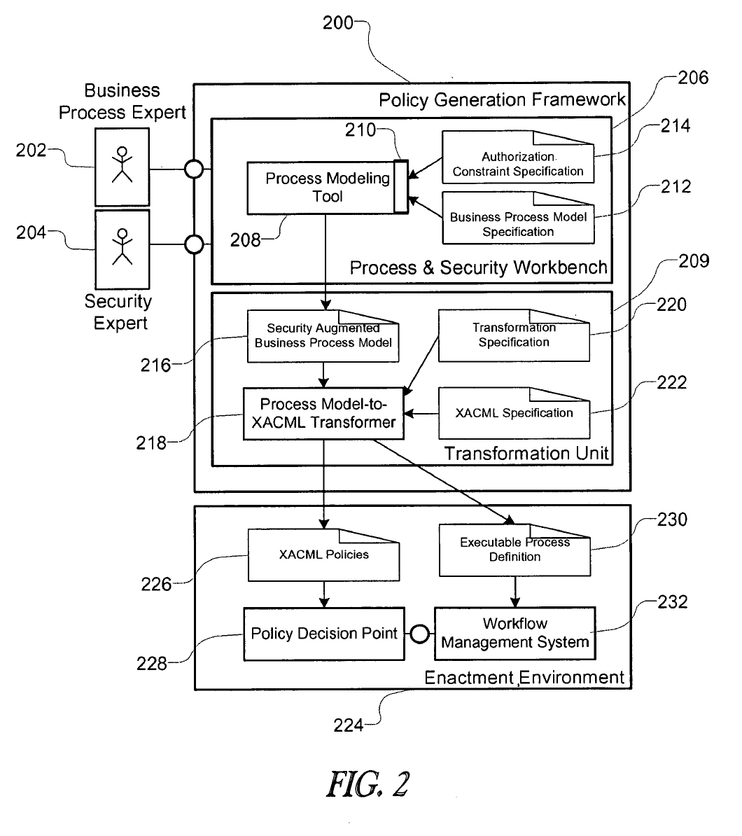

FIG. 2 is a block diagram illustrating a policy generation framework 200, according to example embodiment. The framework 200 is shown to be accessible to both a business process expert 202 and a security expert 204. The framework 200 further includes a process and security workbench 206 and a transformation unit 209. Turning first to the workbench 206, this component includes a process modeling tool 208 that includes an interface 210 to allow the business process expert 202 to generate a business process model specification 212, and which allows both the business process expert 202 and the security expert 204 to collaborate on the specification of an authorization constraint specification 214. Further details regarding the generation of the specifications 212 and 214 by the experts 202 and 204 are described in further detail below with reference to subsequent figures.

The process modeling tool 208 outputs a security augmented business process model 216 to a process model-to-XACML transformer 218. Additional inputs to the transformer 218 include a transformation specification 220 (e.g., a mapping of notations of the augmented business process model to security policies), and an XACML specification 222.

FIG. 2 illustrates that the policy generation framework 200, and specifically the transformer 218, may provide two outputs to an enactment environment 224. Specifically, the transformer 218 outputs one or more security policies 226 (e.g., XACML policies) to a security system 228 (e.g., a policy decision point) and furthermore provides an executable process definition 230 to a workflow management system 232. The security system 228 is shown to be communicably coupled to the workflow management system 232 and enforces access controls applicable to assets and resources of the workflow management system 232. Accordingly, the enactment environment 224 may use the policy specification 226 and process definition 230 as input for runtime enactment and enforcement.

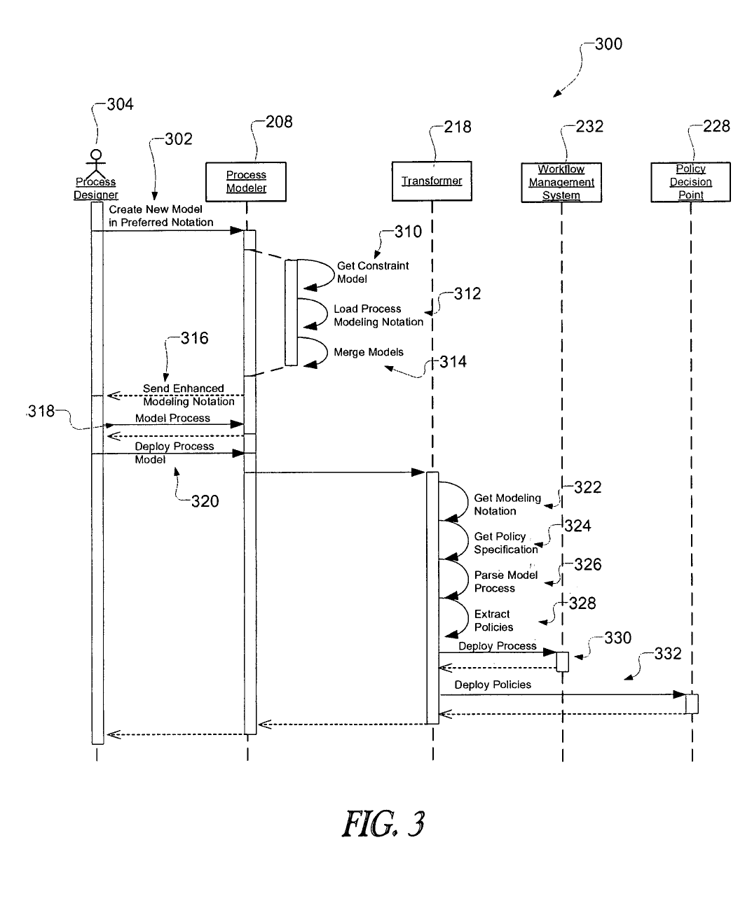

FIG. 3 is an interaction diagram illustrating an overall process modeling and policy generation sequence 300, according to an example embodiment. The sequence 300 will be discussed with reference to the example policy generation framework 200 and enactment environment 224 described above with reference to FIG. 2.

The sequence 300 commences at 302 with a process designer 304 (e.g., a business process designer and/or a security expert) interacting with a process modeling tool 208 that allows for the visual modeling of a business process, based on a process model specification (e.g., BPMN or XPDL). The process designer 304, upon initiating creation of a new model in a preferred notation, causes the process modeling tool 208 to retrieve a constraint model at 3210, and process modeling notation at 312 to generate a merged model at 314. The enhanced modeling notation, generated by the merge operation 314 is communicated and made available to the process designer at 316. Using the enhanced modeling notation the process designer 304 models a business process at 318. Specifically, as noted above, the process modeling tool 208 supports authorization constraint specification (e.g., utilizing the enhanced modeling notation) that is merged with the business process model specification 212 within the process modeling tool 208. Accordingly, authorization constraints may be directly defined at operation 318 within the context of the process model, thereby providing an augmented model for both security domain and business process domain experts. At 320, the process designer 304 may deploy the business process model, causing the newly created security augmented business process model 216 to be provided to the transformer 218.

In an example embodiment, the security annotation may be proprietary, and accordingly the defined security constraints may need to be translated into a platform independent representation. Accordingly, at 322, the transformer 218 may retrieve the transformation specification 220 (e.g., a modeling notation to policy specification mapping) and at 324, may retrieve a policy specification (e.g., the XACML specification 222). At 326, the transformer 218 parses the security augmented business process model 216 and at 328 extracts the authorization constraint annotations from the business process model. The transformer 218 then automatically generates security policies (e.g., XACML policies) that can be deployed within a process enactment environment (e.g. an XACML-enabled policy enactment environment).

At 330, the executable process definition 230 may be deployed to the workflow management system 232, and the extracted security policies (e.g., the XACML policies 226) may be deployed to a security system (e.g., the policy decision point 228) at 332. In an example embodiment, the executable process definition 230 may be stored as a BPEL description. To enforce the specified security constraints at runtime, the derived XACML policies 226 can be deployed within the security system which interacts at runtime with the workflow management system 232 to effectively enforce the specified task-based authorization constraints.

An example embodiment proposes an authorization specification language and modeling approach that may be applied within the context of a workflow or within the context of the process modeling itself. The following section describes integration of a notion of an authorizing constraint into a visual workflow modeling notation (e.g., BPMN), according to an example embodiment. While the below example embodiment is discussed within the context of BPMN, it will of course be appreciated that embodies are not so limited and may be applied to any modeling language or notation.

BPMN is a standardized graphical notation for drawing business processes in a workflow, developed by the Business Process Management Initiative (BPMI) and supports modeling utilizing a set of graphical elements. BPMN provides four basic categories of elements namely flow objects (e.g., events, activities and gateways), connecting objects (e.g., sequence flow, message flow or association), swimlanes (e.g., pool, lane) and artifacts (e.g., data objects, group and annotation). Artifacts enable developers to extend the expressiveness of BPMN, without affecting the basic sequence or message flow of a process model, or without affecting the mapping of the process model to an execution language (e.g., BPEL).

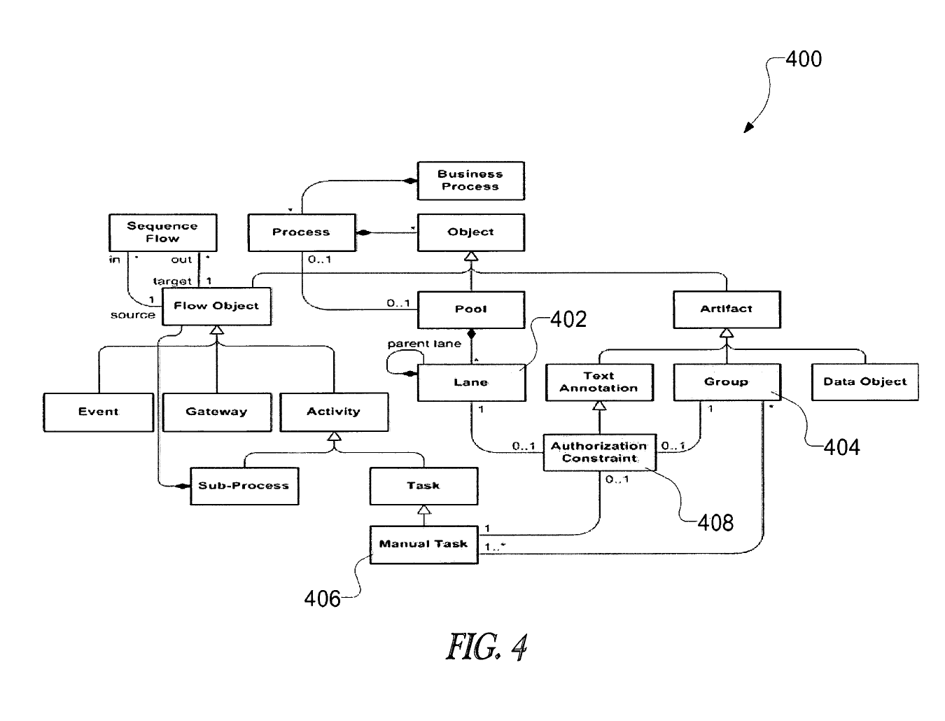

According to an example embodiment, a “constraint artifact” may be derived from the textual annotation element provided within BPMN. FIG. 4 is an entity relationship diagram showing an extract of a BPMN meta-model 400, according to an example embodiment. The entities, named according to the BPMN specification, which may be used to express authorization constraints within BPMN are example embodiments, are highlighted. Specifically, a “lane” swimlane element 402, a “group” artifact 404, a “manual task” activity 406, and an “authorization constraint” artifact 408 may be utilized in an example embodiment to fully express an authorization constraint.

Dealing more specifically with some of the elements of BPMN, an activity (as an example of a flow object) is represented by a rounded-corner rectangle, and denotes a kind of work that needs to be performed. An activity may be a task or a subprocess. FIG. 5 illustrates BPMN notations, according to an example embodiment, and shows specific groupings of tasks and the allocation of tasks to organizational roles utilizing swimlanes. While tasks may be atomic or non-atomic, the example provided herein is restricted to atomic tasks. As shown in FIG. 5, a pool or a lane 502 may contain multiple tasks 504, 506, 508. Each task within BPMN is associated with a Boolean attribute “Manual Task”, which may be used to specify whether the task is manual (e.g., performed by a user), or is automatic (e.g., may be performed in an automated way by a computer system). The lane 502 is used to assign the tasks 504-508 to an organizational role of an access management system, and may refer to classical role-based authorizations. A nested lane 510 may be used to represent role-based task authorization inheritance and role hierarchy.

For example, within a second swimlane 510 illustrated in FIG. 5, a manager role inherits the task authorizations for tasks 512 and 514 from the clerk nested role.

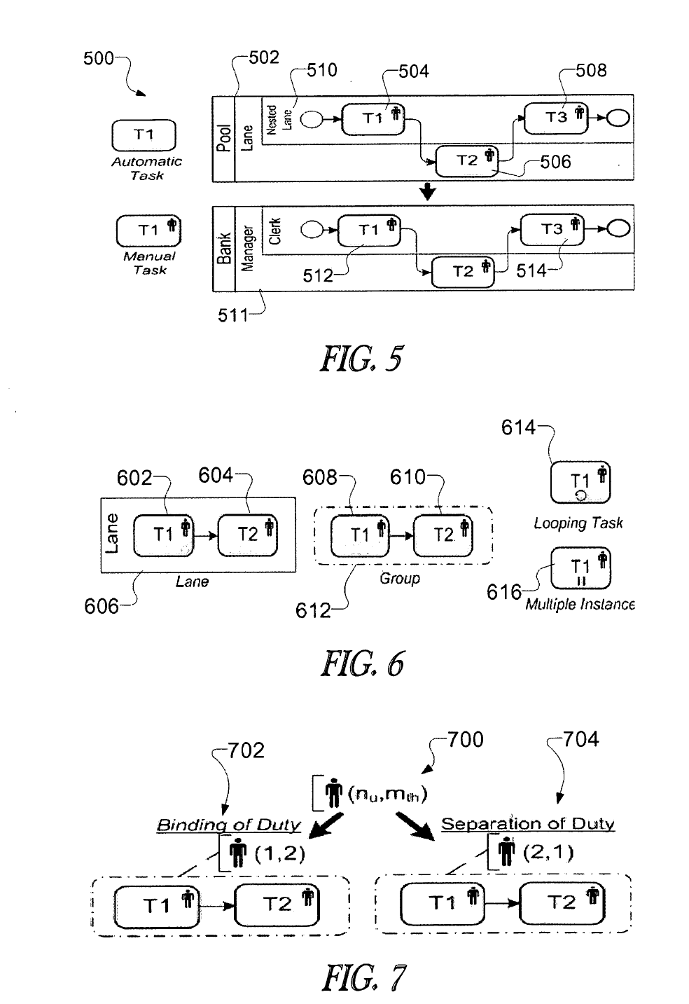

FIG. 6 is a notation diagram illustrating different ways groupings of activities (e.g., tasks) may be expressed, according to an example embodiment. The example notation illustrated in FIG. 6 differentiates between a “grouping” of tasks 602 and 604 within a lane for the purposes of rights management and the grouping of tasks 608 and 610 within a group artifact 612 for the purposes of assigning a dedicated authorization constraint to the group. It should be noted that, within the context of BPMN, groups may be defined using group artifacts, lanes or multiple or looped tasks. A grouping of activities does not necessarily affect a sequence flow, and groups may be used for documentation or analysis purposes. Unlike lanes, group artifacts do not map to roles or groups within the context of rights management, but may be used to define a group of activities and to assign a dedicated authorization constraint to a group. An example embodiment may consider multiple instances of tasks and looped tasks as a group with one task, but with an arbitrary number of task instances. Accordingly, FIG. 6 illustrates various example BPMN elements that may be used as mechanisms for defining groups of tasks. As noted above, looping tasks 614 and multiple instances of a particular task 616 may also be used as mechanisms for defining groups of tasks.

FIG. 7 illustrates an example notation 700 for an authorization constraint artifact which may be defined within the context of BPMN.

Absent an authorization constraint, a group of tasks may have no semantic in the sense of conflicting tasks associated with the group. In the context of conflicting task definition, an example embodiment includes an authorization constraint which is derived from the textual annotation of an entity. While the example embodiment provides a textual annotation, it will be appreciated that any other visual graphical annotations (e.g., a graphical annotation) may be used to reflect and define an authorization constraint. Within the example context of BPMN, text annotations are a mechanism for a modeler to provide additional information to a reader of a BPMN diagram. The example authorization constraint 700 includes two values to provide a formal authorization definition, namely nᵤ and mₜₕ. The value of nᵤ defines a minimum number of different users that have been allocated to a task of a given workflow instance. The value of mₜₕ is defined as a threshold value of a sum of task instances that a user is about to allocate for a given workflow instance.

As shown in FIG. 7, a single authorization constraint (e.g., a “binding of duty” authorization constraint 702 or a “separation of duty” authorization constraint 704) may be associated with a group artifact defining a set of tasks (e.g., manual or automatic tasks), a lane, or may be associated with a single manual task. It may be necessary to allocate an authorization constraint to a single manual case in the case of multiple instances or loops.

Because an organizational role may be defined by a lane, a complete set of authorization constraints for each lane may be based on the assigned constraints for that lane, a nested lane and all constraints assigned to groups and single manual tasks embedded within a corresponding lane, for example.

With the definition of sets of conflicting tasks and the general understanding that the authorization of a user to perform further conflicting tasks of the same set depends on his and other users previous actions in a workflow a task authorization constraint c may be defined for a set of conflicting tasks T_{c} as:

c=(T_{c},nᵤ,mₜₕ),nᵤ,mₜₕεN

The value nᵤ defines the minimal number of different users that have to allocate a task tεT_{c} for a given workflow instance. Let tₖᵢ be an instance of the task t_{κ}. We define mₜₕ as the threshold value of the sum of task instances tₖ_{ᵢ}, ∀tεT_{c} a user uₙ is allowed to allocate for a given workflow instance:

m^{th}(uₙ)=Σ(tₖ_{ᵢ}(uₙ)),∀tεT_{c}

mₜₕ(uₙ)≦mₜₕ,∀uε=U

It should be mentioned that mₜₕ sums up the task instances of all tasks in T_{c}, while nᵤ dictates the number of different users that have to allocate at least one task instance of tasks in T_{c}.

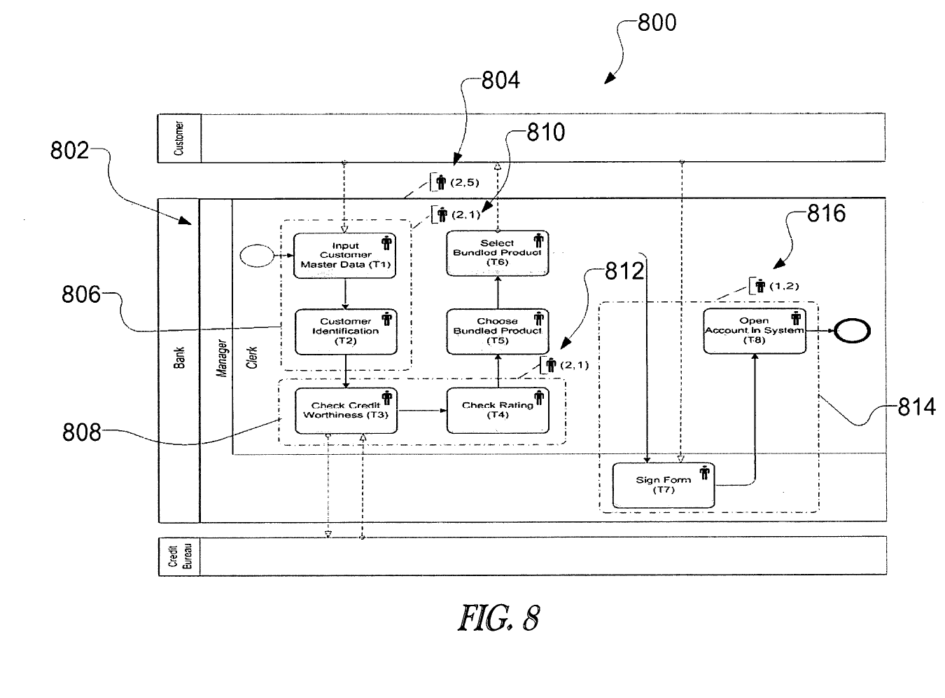

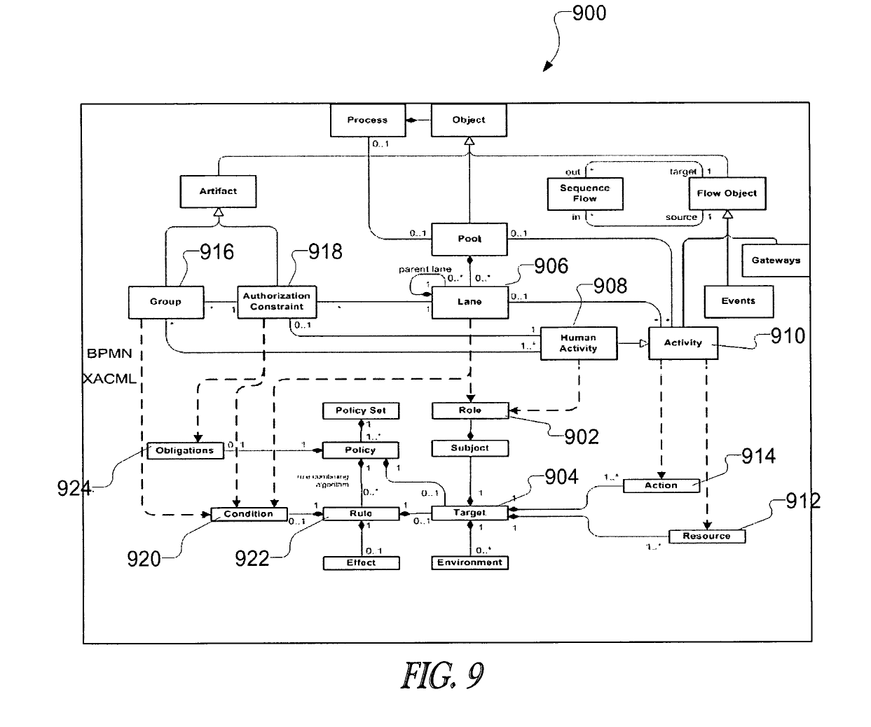

FIG. 8 illustrates a process model 800, according to an example embodiment, for which augmentation has been received via an interface for a number of tasks. The augmentation includes the task-based authorization constraints using the annotation discussed above with reference to the FIGS. 5-7. For example, with respect to the manager role denoted by swimlane 802, the augmenting notation 804 indicates that a minimum of two different users are required to fulfill this role with respect to a total of five different tasks. Within the “clerk” nested lane, two groups 806 and 808 of tasks are defined, each of these groups being augmented with a “separation of duty” constraint artifact indicating that a minimum of two different users have been allocated to the task of groups, with each of the different users being required to perform at least one of the tasks within the group.

A group 814 is shown to be augmented with a “binding of duty” task-based authorization constraint 816 which specifies that the tasks within the group 814 should be performed by a single person, this single person being required to perform a total of two tasks.

It will be appreciated that the augmentation of the task groups 806, 808 and 814 by the visual business process modeling notations 810, 812 and 814 may be received via an interface of a process modeling tool (e.g., the process modeling tool 208 of the process and security workbench 206). Specifically, a convenient drag and drop function may be provided by the interface whereby a user can conveniently select the relevant notation and associate it with a task, or group of tasks, and then can specify the nᵤ and mₜₕ values for each of these authorization artifacts.

Dealing now in further detail with model transformation, as may be performed for example by a transformer 218, an example embodiment is discussed below, in which details are provided of relationships and respective mappings between selected meta-model entities of BPMN and XACML, merely for example. Again, it should be emphasized that example embodiments not limited to the transformation of a process model expressed using BPMN to security policies expressed using XACML, and that these notations and languages are used merely for the purposes of illustration.

FIG. 9 is an entity-relationship diagram illustrating an example process model to XACML mapping 900. As illustrated, XACML subject role attributes 902 of a policy target 904 may be derived from BPMN lanes 906 and nested lanes respectively. To this extent, a BPMN lane represents an organizational role, and thus the semantic of embedded human activities 908 may be interpreted as a role-task assignment.

BPMN elements activity 910 and human activity 908 are mapped to XACML resource elements 912, as part of the policy target 904. In the context of a workflow management system, a process task may be considered as a resource. In the domain of process management, an activity has several possible states that are related to human interaction, namely “activated”, “completed” or “cancelled”. Therefore, for each task, three XACML action elements 914 may be derived for a particular XACML policy target 904.

Group elements 916, lane elements 906 and authorization constraint elements 918 may be mapped, in an example embodiment, onto an XACML condition element 920 of an XACML policy rule 922. A condition element 920 may describe under which circumstances a rule applies to a matching target element 904. This supports fine-grain access control, and enables the expression of separation of duty or binding of duty constraints. In the case of a separation of duty authorization constraint, an XACML condition element 920 is generated, where the condition must not be met. For example, the relevant condition element 920 may specify that a particular task may not be performed by the same subject as another task. Similarly, binding of duty constraints result in an XACML condition element 920 that must be met. For example, the XACML condition element may specify that a subject must have executed a previous activity in order to perform the requested activity.

A BPMN authorization constraint element 918, according to an example embodiment, may also be mapped onto an XACML obligation element 924. An obligation element 924 represents meta-information for an XACML-enabled policy enforcement point, and may contain activities that must be performed by an enforcement point depending on the outcome of a policy evaluation period. For example, in the case of operation on separation and binding of duty constraints, potential obligations for a policy enforcement point may include extended audit information and housekeeping in a backend system to store a subject's activity history information.

The mapping 900 illustrated in FIG. 9 may find the expression in the transformation specification 220, described above with reference to FIG. 2.

In an example embodiment, the transformer 218 of the policy generation framework 200, described above with reference to FIG. 2, may execute an XSLT transformation script that automates the generation of XACML policies 226, and stores such policies 226 in an XML format file, which may be read by an XACML-based policy decision point 228.

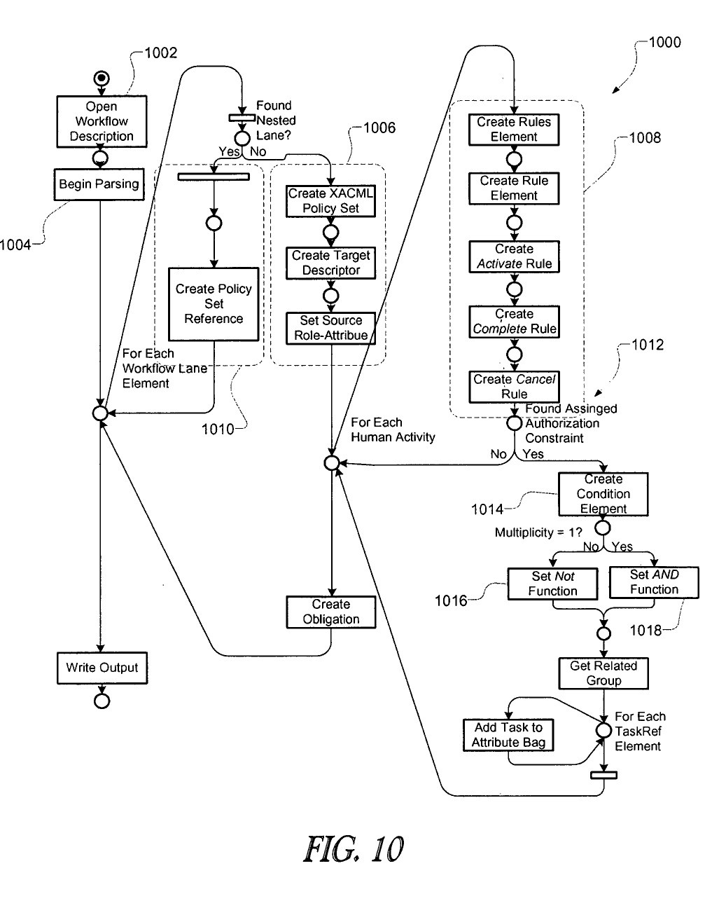

FIG. 10 is a Petri-Net illustrating a policy transformation method 1000, as may be performed by an XSLT transformation script forming part of the transformer 218.

The method 1000 begins at operation 1002 with the opening of a workflow description, whereafter the process model is parsed at operation 1004 for lane elements. For each lane, the transformation script, at operation 1006, generates a role-based policy set, by performing the illustrated operations. For each human activity that is assigned to that lane, a policy and three rules may be created, as illustrated at 1008. These rules allow the actions “activate”, “complete” and “cancel” for each human activity by a subject that holds a role attribute, with the corresponding role being represented by the lane. If the transformer 218 detects a nested lane, a new role-based policy set is created at operation 1010, and its contained policies are referenced by the parent lane. This allows for the expression of role-hierarchies in terms of role seniority.

If the transformer 218 detects an authorization artifact at decision point 1012, a condition element is created and added to the effect of a policy rule at operation 1014. In the case of “separation of duty” constraints, the logical function of the condition is set to NOT at operation 1016. On the other hand, if a “binding of duty” constraint is detected, the logical function of the condition is set to AND at operation 1018. This logical function may be applied to all arguments within the relevant condition element. The authorization constraint reference is a set of activities either by appointing to a group artifact, or to a lane element.

Further, for each human activity defined in a reference task group or lane element, an attribute function is applied to the condition element. This element takes a subject identifier, a process identifier, a set of tasks identifiers (e.g., an argument bag) and an optional threshold value as arguments. An abstract “check: history” function for the XACML context handler may be defined to enable querying of audit log information from workflow systems. Depending on the utilized system, this function may be adapted. The “check: history” function returns “true” or “false” if the subject has performed any of the tasks referenced by the set of tasks in the argument bag.

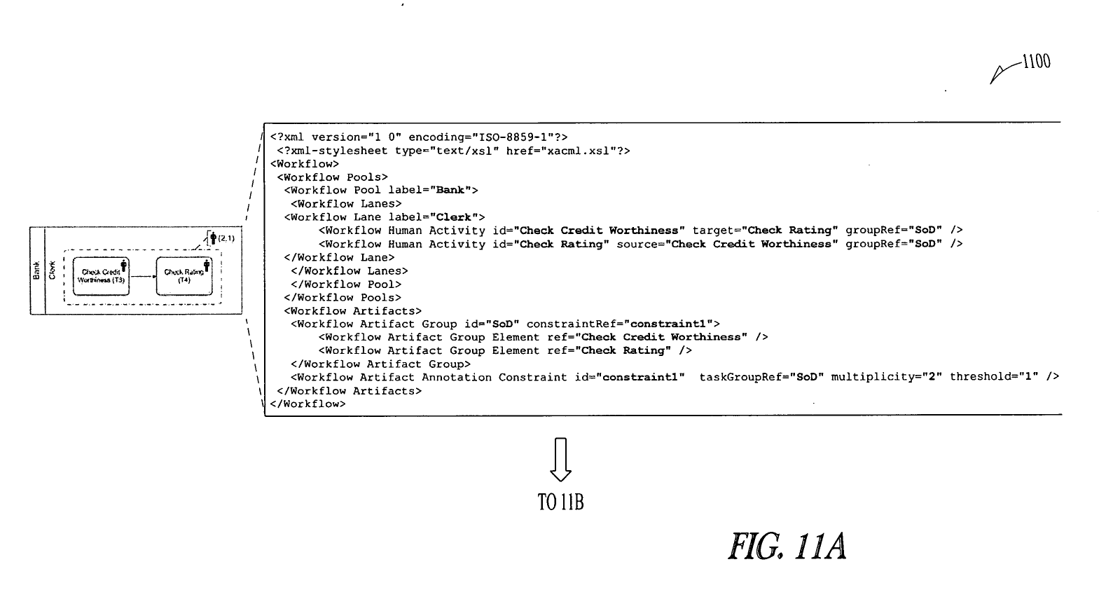

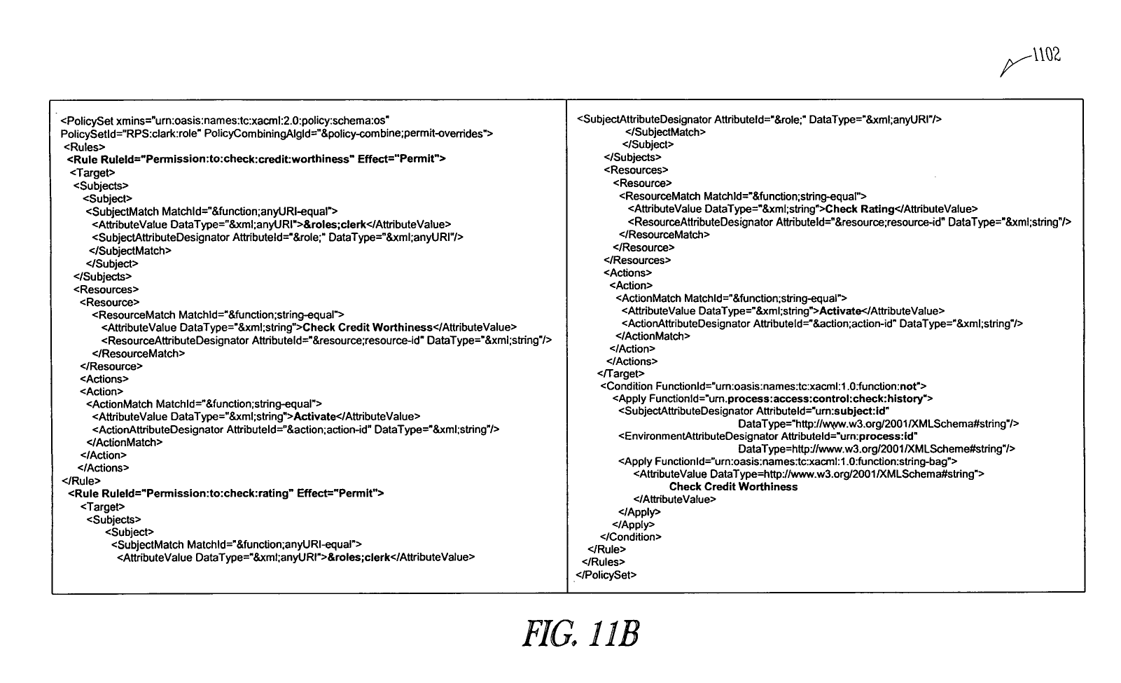

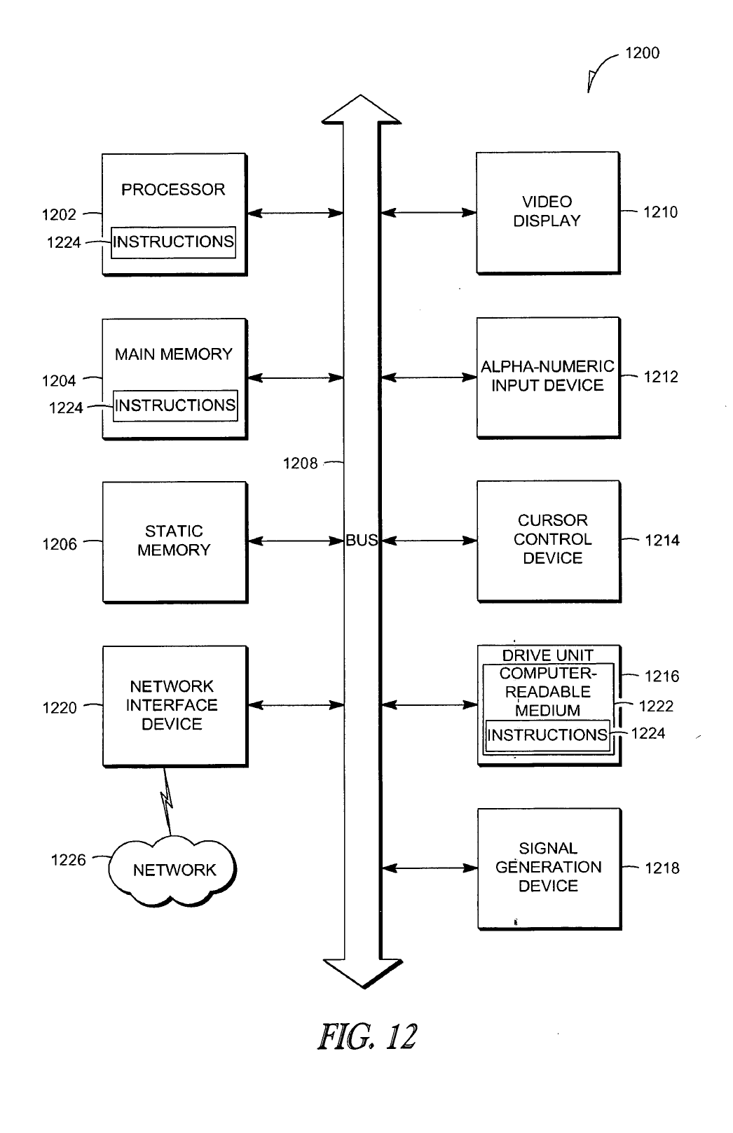

While the example embodiment described herein has been described within the context of a BPMN meta-model, other embodiments may be applied to other process modeling notations (e.g., XPDL or jPDL). The described embodiment may provide a model transformation approach to the automatic derivation of security policies from business process models (as is illustrated in FIG. 11) by addressing the syntactical complexity of the XACML representation of a simple separation of duty policy between tasks. FIG. 11 illustrates the transformation of an XML-formatted BPMN process source 1100 into an XACML-based policy 1102. The automated generation of an XACML policy from a modeling notation (e.g., a BPMN) which is more accessible to humans (as opposed to directly editing XACML policies) may expedite a policy generation process, and tighten collaboration between security domain and business process domain experts. Furthermore, example embodiments may allow for the direct definition of policies in the context of an underlying business process, thus reducing the probability of potential inconsistencies between defined security policies and process models based on model changes.

Further, the usability and the benefits derived from example embodiments of the described compliance extensions for BPMN may be strengthened by the mapping to XACML policies, which can be directly enforced in an enterprise environment. This mapping, in example embodiments, may also seek to reduce the complexity of XACML-based policy administration by defining such policies to a more abstract level.

### Modules, Components and Logic

Certain embodiments are described herein as including logic or a number of modules, components or mechanisms. A module, logic, component or mechanism (herein after collectively referred to as a “module”) may be a tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in dedicated and permanently configured circuitry, or in temporarily configured circuitry (e.g., configured by software) may be driven by cost and time considerations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

### Electronic Apparatus and System

Example embodiments may be implemented in digital electronic circuitry, or in computer hardware, firmware, software, or in combinations of them. Example embodiments may be implemented using a computer program product, e.g. a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination permanently and temporarily configured hardware may be a design choice. Below are set out hardware (e.g., machine) and software architectures that may be deployed, in various example embodiments.

### Example Machine Architecture and Machine-Readable Medium

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of instructions and data structures (e.g., software 1224) embodying or utilized by any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmissiom Medium

The software 1224 may further be transmitted or received over a communications network 1226 using a transmission medium via the network interface device 1220 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving, via an interface, an augmentation of at least one task of a business process model, the augmentation comprising a task-based authorization constraint;
generating an augmented business process model using the business process model and the task-based authorization constraint; and
automatically deriving an authorization policy from the augmented business process model.

2. The method of claim 1, including receiving the task-based authorization constraint via the interface as a visual business process modeling notation for association with at least one task of the business process model.

3. The method of claim 1, including receiving via the interface, a grouping of a plurality of tasks of the business process model, and receiving the augmentation for association with the group.

4. The method of claim 2, wherein the visual business process modeling notation is at least one of a textual notation or a graphical notation.

5. The method of claim 1, wherein the authorization policy automatically derived from the augmented business process model is a role-based control policy.

6. The method of claim 1, wherein at least one task of the business process model is at least one of a manual task, a partially automated task, or a fully automated task.

7. The method of claim 1, wherein the automatic derivation of the authorization policy includes extracting the task-based authorization constraint from the augmented business process model.

8. The method of claim 1, wherein the automatic derivation of the authorization policy includes parsing the augmented business process model to identify and generate a role-based policy component for the authorization policy.

9. The method of claim 1, wherein the automatic derivation of the authorization policy includes detecting the task-based authorization constraint within the augmented business process model, and generating a condition based on the task-based authorization constraint for the authorization policy.

10. The method of claim 9, including determining whether the at least one task is a manual task and, based on the determination, selectively applying an attribute function to the condition.

11. The method of claim 1, including enacting an executable process definition based on the enhanced business process model using a workflow management system.

12. The method of claim 1, including enacting the authorization policy using a security system.

13. A system comprising:
a process modeling component to:
receive an augmentation of at least one task of a business process model, the augmentation comprising a task-based authorization constraint, and
generate an augmented business process model using the business process model and the task-based authorization constraint; and
a transformation component automatically to derive an authorization policy from the augmented business process model.

14. The system of claim 13, wherein the process modeling component is to receive the task-based authorization constraint via the interface as a visual business process modeling notation for association with at least one task of the business process model.

15. The system of claim 13, wherein the process modeling component is to receive grouping of a plurality of tasks of the business process model, and is to receive the augmentation for association with the group.

16. The system of claim 13, wherein the transformation component is to parse the augmented business process model to identify and generate a role-based policy component for the authorization policy.

17. The system of claim 13, including a workflow management system to impact an executable process definition based on the enhanced business process model.

18. The system of claim 13, including a security system to impact the authorization policy.

19. A machine-readable medium embodying instructions that, when executed by processor, cause the processor to:
receive an augmentation of at least one task of a business process model, the augmentation comprising a task-based authorization constraint;
generate an augmented business process model using the business process model and the task-based authorization constraint; and
automatically derive an authorization policy from the augmented business process model.

20. The machine-readable medium of claim 19, wherein the instructions cause the processor to receive the task-based authorization constraint via as a visual business process modeling notation for association with at least one task of the business process model.

21. The machine-readable medium of claim 19, where the instructions cause the processor to receive grouping of a plurality of tasks of the business process model, and to receive the augmentation for association with the group.

22. A system comprising:
first means for:
receiving an augmentation of at least one task of a business process model, the augmentation comprising a task-based authorization constraint, and
generating an augmented business process model using the business process model and the task-based authorization constraint; and
second means for automatically deriving an authorization policy from the augmented business process model.
